(19) United States
(12) Patent Application Publication
(10) Pub. No.: US 2018/0245509 A1
(43) Pub. Date: Aug. 30, 2018

(54) INTERNAL COMBUSTION ENGINE FOR VEHICLE

(71) Applicant: Honda Motor Co.,Ltd., Tokyo (JP)

(72) Inventors: Daichi IKEDA, Saitama (JP); Tomohiko YOSHINO, Saitama (JP)

(73) Assignee: Honda Motor Co.,Ltd., Tokyo (JP)

(21) Appl. No.: 15/836,918

(22) Filed: Dec. 11, 2017

(30) Foreign Application Priority Data
Feb. 24, 2017 (JP) 2017-033590

(51) Int. Cl. F02B 77/02

(52) U.S. Cl. CPC F02B 77/02

(57) ABSTRACT

Provided is an internal combustion engine of a vehicle. An upper surface of a head cover supporting plug top coils is covered with an engine cover. A plug top coil cover is fixed to the upper surface of the head cover. Thereby, an upper passage is formed between the engine cover and the plug top coil cover, and a lower passage is formed between the head cover and the plug top coil cover. The lower passage includes a labyrinth defined by first wall parts provided for the head cover and second wall parts provided for the plug top coil cover. Since it becomes difficult for high-temperature air to flow along the lower passage facing the plug top coils, and easy for it to flow along the upper passage away from the plug top coils, the overheating of the plug top coils caused by contact with the high-temperature air is suppressed.

### CROSS-REFERENCE TO RELATED APPLICATION

This application claims the priority benefit of Japan application serial no. 2017-033590, filed on Feb. 24, 2017. The entirety of the above-mentioned patent application is hereby incorporated by reference herein and made a part of this specification.

### BACKGROUND OF THE DISCLOSURE

### Field of the Disclosure

The present disclosure relates to an internal combustion engine for a vehicle in which an upper surface of a head cover supporting a plug top coil is covered with an engine cover.

### Description of Related Art

Since a variety of pipes, wires, etc. are arranged around a head cover of an internal combustion engine mounted in an engine compartment of a vehicle, there is a problem in that beauty of the internal combustion engine viewed when a hood is opened are degraded. Therefore, an engine cover is designed to be attached to an upper surface of the head cover of the internal combustion engine to conceal the pipes, wires, and the like. Thereby, an exterior of the internal combustion engine is organized, and the beauty is enhanced. Since a plug top coil connected to an ignition plug is supported by a head cover of the internal combustion engine, the plug top coil is covered with the engine cover attached to the head cover.

### SUMMARY OF THE DISCLOSURE

Meanwhile, the engine cover also has a function of blocking noise made by the internal combustion engine to prevent the noise from being transmitted to a passenger compartment. However, since the engine cover is elastically supported by the head cover via a rubber bush such that vibrations of the engine cover itself do not contribute to the noise, a gap is inevitably generated between an outer circumference of the engine cover and the head cover. Since high-temperature exhaust system parts such as an exhaust pipe or a turbocharger are arranged around the internal combustion engine, when high-temperature air heated by these exhaust system parts infiltrates the engine cover from the gap, the plug top coil that is easily heated to a high temperature by its own heat generation comes into contact with the high-temperature air and is further heated, and has a possibility of exerting a bad influence on its durability. Therefore, even when a tip of the engine cover is adapted to extend to obstruct heat, the engine cover cannot be rigidly fixed. For this reason, there is a problem that the engine cover moves during travel, and inflow of the heat is not blocked.

The present disclosure was made in view of the above circumstances, and is directed to preventing overheating of a plug top coil covered with an engine cover of an internal combustion engine for a vehicle.

To achieve the above object, according to the disclosure described in claim 1, there is a proposal for an internal combustion engine for a vehicle in which an upper surface of a head cover supporting plug top coils is covered with an engine cover, wherein a plug top coil cover is fixed to the upper surface of the head cover, and thereby an upper passage is formed between the engine cover and the plug top coil cover, and a lower passage facing the plug top coils is formed between the head cover and the plug top coil cover. The lower passage includes a labyrinth defined by first wall parts provided for the head cover and second wall parts provided for the plug top coil cover.

According to the disclosure described in claim 2, in addition to the configuration of claim 1, the internal combustion engine is transversely mounted such that a cylinder row line runs in a vehicle width direction, exhaust system parts are disposed at a front side of the head cover, and the labyrinth is located at a front side relative to the plug top coils.

According to the disclosure described in claim 3, in addition to the configuration of claim 2, the first wall parts are wall parts of a breather chamber that protrudes on the upper surface of the head cover, and the second wall parts are located at outer sides relative to the first wall parts.

According to the disclosure described in claim 4, in addition to the configuration of claim 2 or 3, a rear end of the plug top coil cover includes a flexure part bent to the upper passage side above the plug top coils.

An upper wall 13a and a front wall 13b of the breather chamber 13 of the embodiment correspond to the first wall parts of the present disclosure, and a front wall 17d and an upper wall 17e of the plug top coil cover 17 of the embodiment correspond to the second wall parts of the present disclosure. A turbocharger 24 of the embodiment corresponds to the exhaust system part of the present disclosure.

According to the configuration of claim 1, the upper surface of the head cover supporting the plug top coils is covered with the engine cover, and the plug top coil cover is fixed to the upper surface of the head cover, and thereby the upper passage is formed between the engine cover and the plug top coil cover, and the lower passage facing the plug top coils is formed between the head cover and the plug top coil cover. For this reason, when high-temperature air around the internal combustion engine enters the inside of the engine cover, the high-temperature air is adapted to flow along the upper passage and the lower passage. At this time, since the lower passage includes the labyrinth defined by the first wall parts provided for the head cover and the second wall parts provided for the plug top coil cover, it becomes difficult for the high-temperature air to flow along the lower passage facing the plug top coils, and easy for it to flow along the upper passage away from the plug top coils. Thus, overheating of the plug top coils caused by contact with the high-temperature air is suppressed. Moreover, since the plug top coil cover is made up of a member independent of the engine cover and is fixed to the head cover without being fixed to the engine cover, the existing head cover and/or the existing engine cover can be used without a change in design, and a rise in a manufacturing cost of the head cover and/or the engine cover and a reduction in beauty of the engine cover can be avoided.

According to the configuration of claim 2, the internal combustion engine is transversely mounted such that a cylinder row line runs in a vehicle width direction, exhaust system parts are disposed at a front side of the head cover, and the labyrinth is located at a front side relative to the plug top coils. For this reason, traveling wind heated by the exhaust system parts of a high temperature is obstructed by the labyrinth, and it becomes hard for it to reach the plug top coils. Thereby, an anti-overheating effect of the plug top coils caused by the labyrinth can be more effectively exhibited.

According to the configuration of claim 3, the first wall parts are wall parts of a breather chamber that protrudes on the upper surface of the head cover, and the second wall parts are located at outer sides relative to the first wall parts. For this reason, the first wall parts of the existing breather chamber can be used in the head cover with no change to configure the labyrinth, and the manufacturing cost can be cut compared to a case in which a separate member for configuring the labyrinth is provided for the head cover.

According to the configuration of claim 4, since the rear end of the plug top coil cover includes the flexure part bent to the upper passage side above the plug top coils, rigidity and strength of the plug top coil cover can be enhanced by the flexure part. In addition to this, high-temperature traveling wind flowing along the upper passage from the front to the rear is deflected away from the plug top coils by the flexure part of the plug top coil cover, and thereby a rise in temperature of the plug top coils can be more reliably prevented.

### BRIEF DESCRIPTION OF THE DRAWINGS

FIG. 1 is a top view of a head cover of an internal combustion engine.

FIG. 2 is an exploded perspective view of a head cover, a plug top coil cover, and an engine cover.

FIG. 3 is a sectional view taken along line 3-3 of FIG. 1.

### DESCRIPTION OF THE EMBODIMENTS

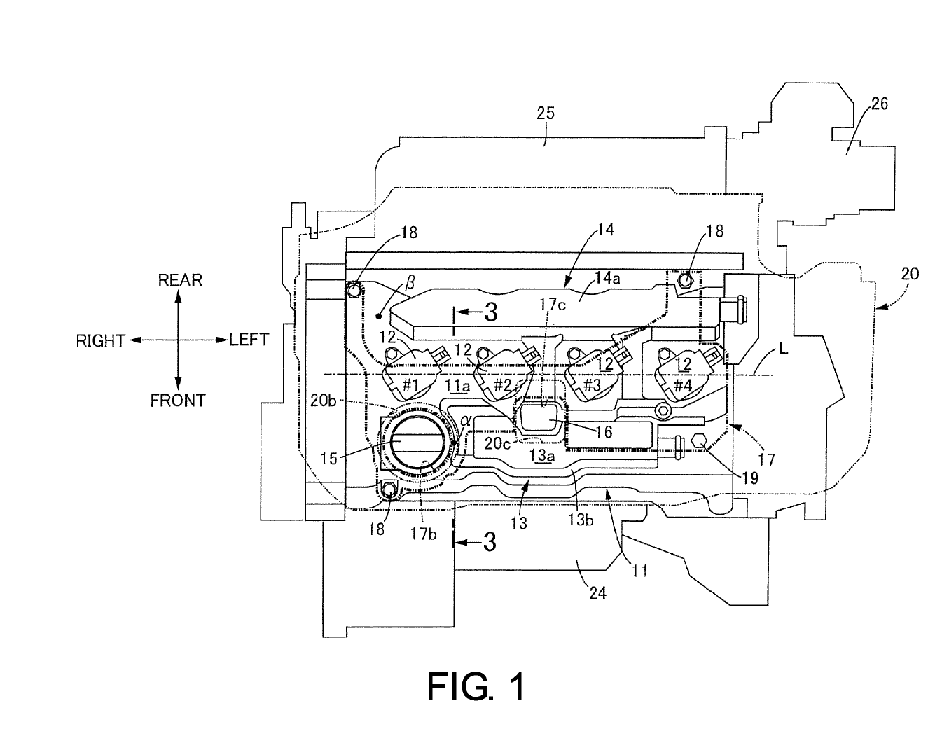

Hereinafter, an embodiment of the present disclosure will be described on the basis of FIGS. 1 to 3.

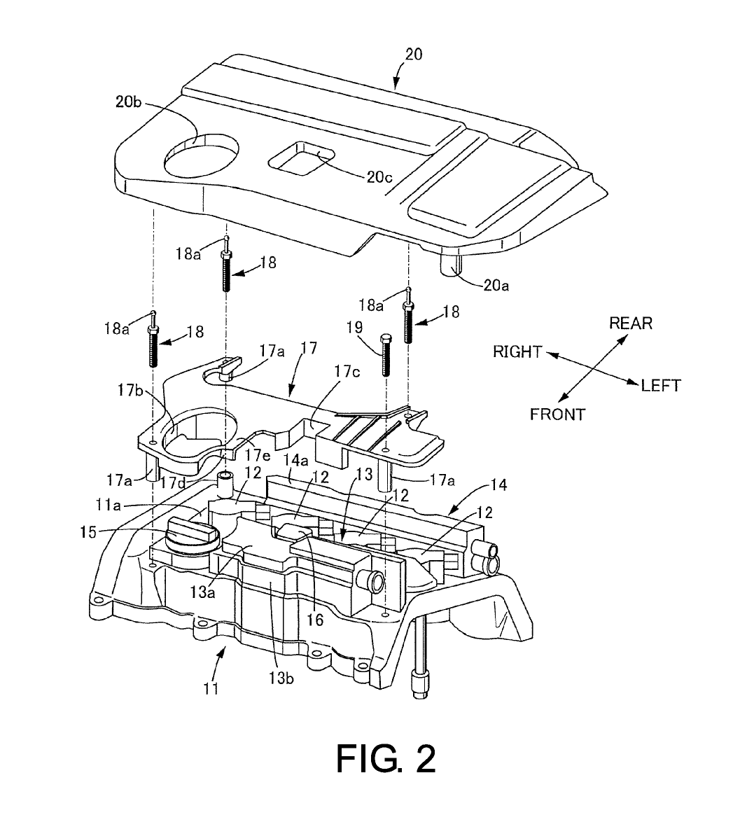

As illustrated in FIGS. 1 and 2, a straight four-cylinder internal combustion engine for a vehicle is transversely mounted in an engine compartment such that a cylinder row line L connecting four cylinders runs in a vehicle width direction, and is configured such that exhaust system parts such as a turbocharger 24 are arranged at a vehicle body front side thereof, and intake system parts such as an intake manifold 25, a throttle valve 26, etc. are arranged at a vehicle body rear side thereof.

Four plug top coils 12 are supported on an upper wall 11a of a head cover 11 formed of a synthetic resin containing a glass fiber along the cylinder row line L.

These plug top coils 12 are connected to four ignition plugs (not shown) provided for a cylinder head, and generate a high voltage required for discharge of the ignition plugs.

Front and rear breather chambers 13 and 14 extending in the vehicle width direction to hold the plug top coils 12 between the front and the rear are formed inside the head cover 11. Upper walls 13a and 14a of the breather chambers 13 and 14 protrude upward from the upper wall 11 a of the head cover 11 by one step. An oil filler cap 15, which blocks an oil fill port for injecting oil into the inside of the internal combustion engine, is provided at a position adjacent to a right end of the front breather chamber 13 to protrude upward from the upper wall 11 a of the head cover 11. An upper end of an oil level gauge 16 protrudes upward from a position adjacent to a rear wall of a middle portion of the front breather chamber 13 in the vehicle width direction.

A plug top coil cover 17 covering an upper side of the head cover 11 is a plate-like member formed of a synthetic resin, and is fastened to the head cover 11 by four bolts 18 and 19 that pass through boss parts 17a, which are provided in four places of a lower surface thereof, from top to bottom. Most of the plug top coil cover 17 excluding the two rear boss parts 17a and 17a is located at a front side relative to the cylinder row line L, a portion thereof corresponding to cylinder #1 particularly largely overhangs forward, a circular opening 17b into which the oil filler cap 15 is fitted is formed in the portion, and a notch 17c into which the upper end of the oil level gauge 16 is fitted is formed at a position adjacent to the opening 17b.

An engine cover 20 covering the upper sides of the head cover 11 and the plug top coil cover 17 is a plate-like member that is larger than a plane shape of the head cover 11 and is formed of a synthetic resin, and is elastically supported by the head cover 11 in a floating state. That is, pins 18a protrude upward from heads of the three bolts 18 among the four bolts 18 and 19 for fastening the plug top coil cover 17 to the head cover 11, tips of the pins 18a are fitted into three rubber bushes (not shown) provided on a lower surface of the engine cover 20, and one pin (not shown) provided for the cylinder head is fitted into one rubber bush (not shown) provided inside a boss part 20a projected on the lower surface of the engine cover 20. Thereby, the engine cover 20 is supported in the floating state to be in direct contact with neither the plug top coil cover 17 nor the head cover 11.

The engine cover 20 includes a circular opening 20b that overlaps the opening 17b of the plug top coil cover 17, and a quadrilateral opening 20c that overlaps the notch 17c of the plug top coil cover 17. The oil filler cap 15 is exposed from the circular opening 20b, and the oil level gauge 16 is exposed from the quadrilateral opening 20c.

An upper surface of the engine cover 20 is designed for text or an image, and conceals pipes, wires, etc. arranged around the head cover 11. Thereby, the engine cover has a function of organizing an exterior of the internal combustion engine to enhance beauty as well as a function of blocking noise generated by the internal combustion engine to prevent the noise from being transmitted to the passenger compartment. If the engine cover 20 is rigidly fastened to the head cover 11, there is a possibility of the engine cover 20 itself causing film surface vibration and increasing the noise. However, the engine cover 20 is elastically supported via the rubber bushes, and thereby the film surface vibration of the engine cover 20 is prevented.

The plug top coils 12 of cylinders #2 to #4 are hidden in a valley between the front and rear breather chambers 13 and 14. However, a space a between the right end of the front breather chamber 13 and the oil filler cap 15 is formed in the front of the plug top coil 12 of cylinder #1, and a space 13 at an outer side relative to a right end of the rear breather chamber 14 is formed in the rear of the plug top coil 12 of cylinder #1.

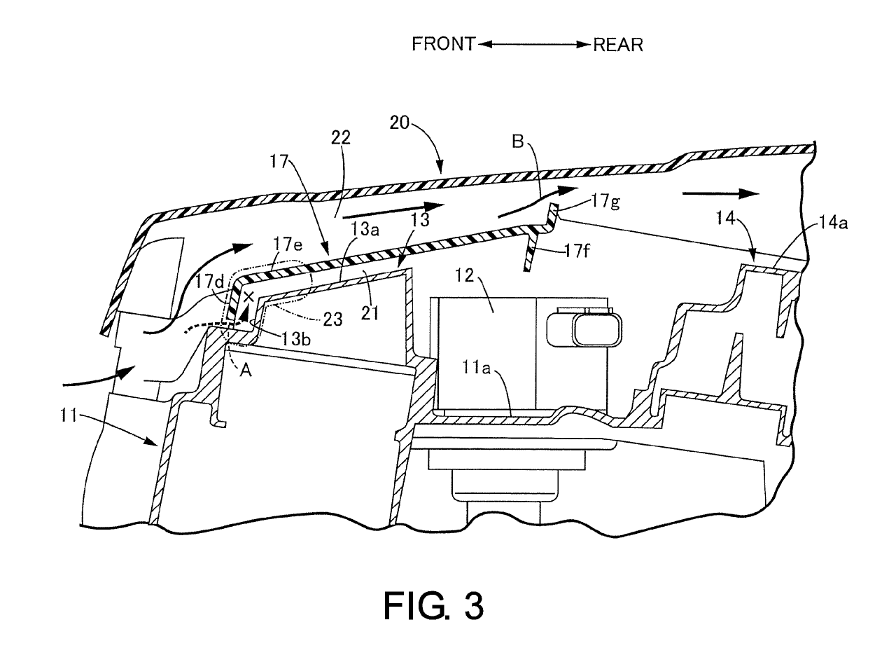

FIG. 3 is a sectional view cutting the head cover 11, the plug top coil cover 17, and the engine cover 20 of the internal combustion engine in the vicinity of the plug top coil 12 of cylinder #1 at a right angle with respect to the cylinder row line L, wherein the left side is the front (an exhaust side) and the right side is the rear (an intake side).

The engine cover 20 supported in the floating state as described above slightly moves relative to the head cover 11 due to elastic deformation of the rubber bushes. However, at the time of the relative movement, a gap between an outer circumferential portion of the engine cover 20 and the head cover 11 is formed not to come into contact with the head cover 11. A gap constituting a lower passage 21 is formed between the head cover 11 and the plug top coil cover 17, and a gap constituting an upper passage 22 is formed between the plug top coil cover 17 and the engine cover 20. When a vehicle travels forward at the left side in the figure, traveling wind that comes into contact with the exhaust system parts such as the turbocharger 24 or the like and reaches a high temperature flows from the gap between the head cover 11 and the engine cover 20 into the lower passage 21 and the upper passage 22.

At this time, the space a between the right end of the front breather chamber 13 and the oil filler cap 15 is formed in the front of the plug top coil 12 of cylinder #1, and the space β at the outer side relative to the right end of the rear breather chamber 14 is formed in the rear of the plug top coil 12 of cylinder #1 (see FIG. 1). For this reason, the plug top coil 12 of cylinder #1 is heated by the high-temperature traveling wind which flows into the inside of the engine cover 20 along the spaces a and 13, and the temperature thereof easily becomes higher than that of the plug top coils 12 of cylinders #2 to #4.

However, at an inlet end of the lower passage 21, a front wall 17d extending in an upward/downward direction of a front end of the plug top coil cover 17 and an upper wall 17e extending in a forward/backward direction are opposite to a front wall 13b extending in an upward/downward direction of the front breather chamber 13 and the upper wall 13a extending in a forward/backward direction, and a labyrinth 23 bent there at an approximately right angle is defined. For this reason, the high-temperature traveling wind is hindered by the labyrinth 23, and it becomes hard for it to flow along the lower passage 21 (see an arrow A of FIG. 3). Since most of the high-temperature traveling wind flows along the upper passage 22, it is difficult for the high-temperature traveling wind to come into contact with the plug top coil 12 of cylinder #1 which faces the lower passage 21, and a reduction in durability due to overheating of the plug top coil 12 of cylinder #1 is avoided.

Moreover, a flexure part 17f bent downward at a right end of the upper wall 17e of the plug top coil cover 17 in the figure and a flexure part 17g bent upward are formed around the plug top coil 12 of cylinder #1. Thus, rigidity of the plug top coil cover 17 is enhanced by the flexure parts 17f and 17g. In addition to this, especially due to the flexure part 17g bent upward, high-temperature cooling wind flowing along the upper passage 22 is deflected away from the plug top coil 12 of cylinder #1 (see an arrow B of FIG. 3), and thereby it becomes more difficult for the high-temperature cooling wind to come into contact with the plug top coil 12 of cylinder #1, and the overheating of the plug top coil 12 of cylinder #1 is more reliably avoided.

As described above, according to the present embodiment, even when there is fear of the high-temperature traveling wind flowing between the head cover 11 and the engine cover 20 running against the specified plug top coils 12 and 12 and overheating occurring, it is difficult for the high-temperature traveling wind to run against the specified plug top coils 12 due to the labyrinth 23 formed by the plug top coil cover 17 disposed between the head cover 11 and the engine cover 20, and thereby temperatures of all of the plug top coils 12 can be made uniform to secure durability.

Especially, when the internal combustion engine is transversely disposed such that the cylinder row line L runs in the vehicle width direction, and the high-temperature exhaust system parts are disposed at the front side thereof, a possibility of the high-temperature traveling wind whose temperature is raised by coming into contact with the high-temperature exhaust system parts flowing between the head cover 11 and the engine cover 20 and overheating the plug top coils 12 becomes high. However, in this case, the labyrinth 23 of the plug top coil cover 17 is disposed in front (upstream in a flow direction of the traveling wind) of the plug top coils 12, and thereby an anti-overheating effect caused by the labyrinth 23 is significantly exhibited.

Forming the labyrinth 23 by changing shapes of the existing head cover 11 and engine cover 20 can also be considered. However, in this case, there is a problem that a manufacturing cost is remarkably raised by design changes of the head cover 11 and the engine cover 20. In contrast, according to the present embodiment, since the overheating of the plug top coils 12 can be prevented by merely adding the new plug top coil cover 17 while using the existing head cover 11 and engine cover 20 with no change, the rise of the manufacturing cost can be suppressed to the minimum

To be specific, the front wall 13b and the upper wall 13a of the existing breather chamber 13 are used in the head cover 11 with no change, and face the front wall 17d and the upper wall 17e of the plug top coil cover 17 at the outer sides (the front and upper sides) thereof, thereby constituting the labyrinth 23. Thus, the design change of the head cover 11 is unnecessary, and the rise of the manufacturing cost is suppressed to the minimum.

In addition, fastening the plug top coil cover 17 to the head cover 11 side as well as the engine cover 20 side can also be considered. However, in this case, there is a problem that a fastening member such as a screw is exposed on a surface of the engine cover 20, and designability of the engine cover 20 is reduced. In contrast, according to the present embodiment, the plug top coil cover 17 is fastened to the head cover 11 side, and thereby the reduction in the designability of the engine cover 20 can be avoided.

While an embodiment of the present disclosure has been described, the present disclosure can be subjected to changes in design in various ways without departing from the scope thereof.

For example, the internal combustion engine of the present disclosure is not limited to the straight multicylinder internal combustion engine of the embodiment, and may be another internal combustion engine such as a V-type multicylinder internal combustion engine.

The upper and lower sides in the present disclosure are not defined as upper and lower sides in a vertical direction, the head cover 11 side is defined as the upper side, and the opposite side thereof is defined as the lower side on the basis of a crankshaft side of the internal combustion engine.

What is claimed is:

1. An internal combustion engine for a vehicle in which an upper surface of a head cover (11) supporting plug top coils (12) is covered with an engine cover (20), wherein:
a plug top coil cover (17) is fixed to the upper surface of the head cover (11), such that an upper passage (22) is formed between the engine cover (20) and the plug top coil cover (17), and a lower passage (21) facing the plug top coils (12) is formed between the head cover (11) and the plug top coil cover (17), wherein the lower passage (21) includes a labyrinth (23) defined by first wall parts (13a, 13b) provided for the head cover (11) and second wall parts (17d, 17e) provided for the plug top coil cover (17).

2. The internal combustion engine for a vehicle according to claim 1, wherein the internal combustion engine is transversely mounted such that a cylinder row line (L) runs in a vehicle width direction, exhaust system parts (24) are disposed at a front side of the head cover (11), and the labyrinth (23) is located at a front side relative to the plug top coils (12).

3. The internal combustion engine for a vehicle according to claim 2, wherein the first wall parts (13a, 13b) are wall parts of a breather chamber (13) that protrudes on the upper surface of the head cover (11), and the second wall parts (17d, 17e) are located at outer sides relative to the first wall parts (13a, 13b).

4. The internal combustion engine for a vehicle according to claim 2, wherein a rear end of the plug top coil cover (17) includes a flexure part (17g) bent to the upper passage (22) side above the plug top coils (12).

5. The internal combustion engine for a vehicle according to claim 3, wherein a rear end of the plug top coil cover (17) includes a flexure part (17g) bent to the upper passage (22) side above the plug top coils (12).
